(19) United States
(12) Patent Application Publication
(10) Pub. No.: US 2014/0039857 A1
(43) Pub. Date: Feb. 6, 2014

(54) EMOTIONAL ANALYTICS FOR PERFORMANCE IMPROVEMENT

(71) Applicant: Daniel A. Hill, St. Paul, MN (US)

(72) Inventor: Daniel A. Hill, St. Paul, MN (US)

(21) Appl. No.: 13/828,783

(22) Filed: Mar. 14, 2013

Related U.S. Application Data
(60) Provisional application No. 61/707,600, filed on Sep. 28, 2012.
(60) Provisional application No. 61/679,540, filed on Aug. 3, 2012.
(60) Provisional application No. 61/763,826, filed on Feb. 12, 2013.

(51) Int. Cl. G06F 17/50

(52) U.S. Cl. CPC G06F 17/5009
USPC 703/6

(57) ABSTRACT

Systems and techniques for emotional analytics for performance improvement are described herein. Performance data of a subject can be received including a specific performance event. Emotional data of the subject corresponding to the specific performance event can be received. A plan to achieve a performance goal for the subject can be determined based on both the performance data and the emotional data. The plan can be presented to a user.

### CLAIM OF PRIORITY

This patent application claims the benefit of priority, under 35 U.S.C. §119(e), to U.S. Provisional Patent Application Ser. No. 61/679,540, titled “ENHANCED ATHLETE MANAGEMENT VIA EMOTION ANALYSTICS,” filed Aug. 3, 2012, U.S. Provisional Patent Application Ser. No. 61/707,600, titled “EMOTIONAL ANALYTICS VISUALIZATION,” filed Sep. 28, 2012, and U.S. Provisional Patent Application Ser. No. 61/763,826, titled “AUTOMATED PRESENT AND PREDICTIVE EMOTIONAL MODELING,” each of which is hereby incorporated by reference in its entirety.

### BACKGROUND

Assessing and improving a person's performance can include observation of a performance, assessment of the performance, and feedback to indicate how the performance can be improved. Typically, these actions are performed by the performer or by a coach of the performer. Athletes are often subjects to such performance improvement efforts. Athlete management can include the scouting, recruiting, coaching, and retaining of athletes. Athlete management is generally performed by experienced individuals such as coaches, managers, or team owners. These individuals typically embody significant knowledge about their sport.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a system for emotional analytics for performance improvement, according to an embodiment.

FIG. 2 illustrates an example of a performance feedback element, according to an embodiment.

FIG. 3 illustrates an example of a method for emotional analytics for performance improvement, according to an embodiment.

FIG. 4 is a block diagram illustrating an example of a machine upon which one or more embodiments may be implemented.

### DETAILED DESCRIPTION

Emotional training is an existing gap in the knowledge applied by many performance analysts. By adding emotional evaluation a performance analyst can increase the accuracy of their advice. For example, in sport, the higher the level of athletic competition, generally, the lower the variance in performers' athletic ability. Thus, the performers' raw athletic ability is less of a differentiating factor between successful and unsuccessful athletes at this high level of competition. A differentiating factor between the successful and unsuccessful athletes can be referred to as a “mental edge.” Such a mental edge can include one or more emotional components, such as resilience, confidence, motivation, focus, satisfaction, patience, coach-ability, compatibility with teammates, or ability to fight through choking or burning-out. Because many performance analysts lack the emotional training to succinctly quantify this mental edge, their performance can be improved by employing emotional analytics for performance improvement of performers (e.g., subjects).

Further, emotional evaluation can be used to provide a feedback loop to the subject so that they can improve themselves. The feedback can include a visualization (e.g., recording) of a specific performance event. Specific performance events can include a play in a competition, a period of time during practice, a speech, a conducting a meeting, etc. The visualization can be accompanied (e.g., alongside or superimposed upon) emotional analytics of the subject from the specific performance event. Thus, a subject can be exposed to both their performance and to their underlying emotional state.

Emotional analytics can be used to help subjects outside of the sports arena as well. For example, a new executive may falter during a speech to a large audience. A mentor can use emotional analytics to discover that the subject expressed a high level of anxiety even though the subject asserted that he was not nervous but rather under-the-weather. The mentor now has the information to create a confidence building plan for the new executive to improve future performance. Although the following examples focus on sporting applications of emotional analytics for performance improvement, the described techniques and systems can be used for non-sport applications.

Applying emotional analytics to performance improvement can extend existing methods coaches or performers use to achieve a variety of performance goals. Additional examples of emotional analytics for performance improvement are described below.

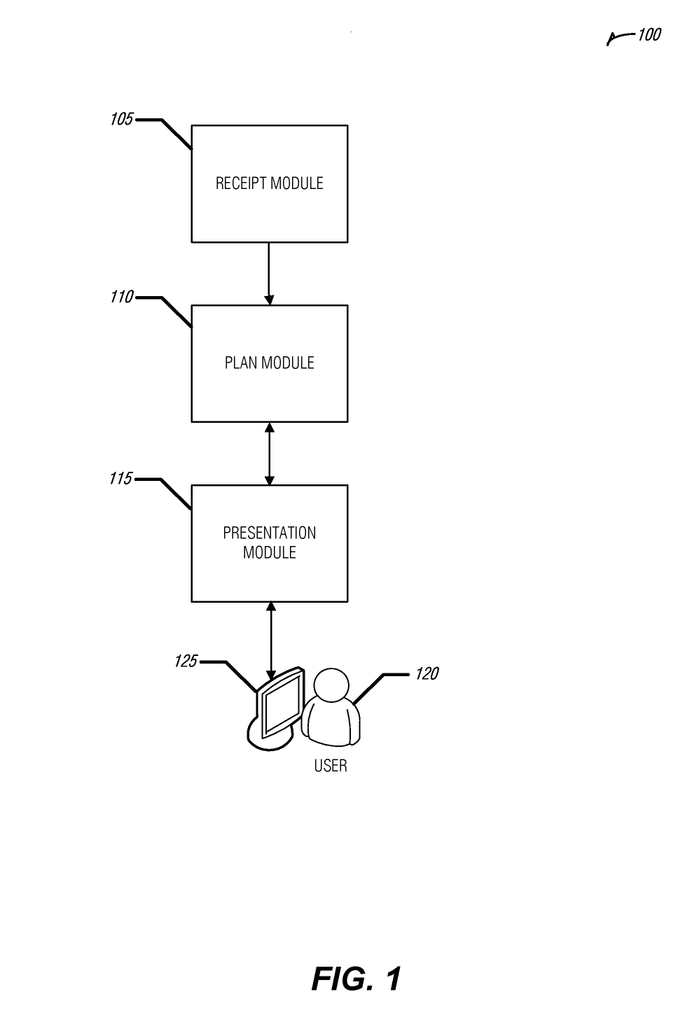

FIG. 1 illustrates an example of a system 100 for emotional analytics for performance improvement. The system 100 can include a receipt module 105, a plan module 110, and a presentation module 115. In an example, the presentation module 115 can be arranged to communicatively couple to a terminal 125 (e.g., a computer, display, mobile device, etc.) to present to a user 120.

The receipt module 105 can be arranged to receive performance data of a subject. The performance data can include a specific performance event. A specific performance event is any defined period of performance of the subject. For example, a play in a hockey game can be a specific performance event. In another example, an inning in a baseball game can be a specific performance event. In another example, an opening monologue to a ceremony can be a specific performance event. Thus, a specific performance event can include any period of activity in which the subject can be observed. In an example, the specific performance event can be for a time period during a competitive event of the sport. For example, the first period of a hockey game. Thus, the analysis will be focused on the subject's performance during competition. Such analysis can provide important clues as to how a subject is handling, for example, the pressures of competition. Such clues can provide predictive information of, for example, longevity in the sport, or compatibility problems with teammates.

In an example, the specific performance event is of a time period during a non-competitive event of the sport. For example, during practice, spring training, or recruitment, the emotional state of the subject may be tested. Often, before an athlete competes at a given level (e.g., collegiate or professional) such non-competitive data is all that is available. In an example, the specific performance event is an interview. For example, a newly recruited football player participates in a press conference accepting the position. The subject's emotional responses can be modeled to, for example, determine that the subject is truly excited (or disappointed) about the team, coach, other players, or any number of other factors related to joining the team.

In an example, the performance data can correspond to a sport. A sport is any activity that is a competition between the subject and other parties.

Thus, a sport can be a traditional team sport such as soccer, and a sport can also be an individual activity such as debate. In an example, the performance data can include performance statistics of the subject in the sport. Such performance statistics can include things like shot percentage from a particular field location, goals, assists, and other statistics routinely compiled by sport statisticians. In an example, the performance data can include performance statistics of a person other than the subject in the sport. In an example, the performance statistics of the other person can be for a position occupied by the subject. For example, if the subject is a second basemen, the performance statistics can include those of other second basemen. These performance statistics can facilitate plan creation (discussed below) because of the generally copious amount of data gathering that goes on in sport. Thus, a large amount of situational performance data can be included in the performance data and correlated via emotional analytics to the specific event of the subject.

In an example the receipt module 105 can be arranged to present a simulation of an event of the sport. In an example, the simulation can be a written or verbally administered scenario of competition, such as, “what play would you call given a particular down, line-up, and time remaining in the game?” In an example, the simulation can include an electronic simulation, such as a video game or virtual reality scenario of play. The receipt module 105 can be arranged to collect performance data of the subject for the simulation. For example, if the subject has not played in the outfield before, the subject's performance data can be augmented with the subject's performance in an outfield simulation.

The receipt module 105 can be arranged to receive emotional data of the subject corresponding to the specific performance event. The emotional data can include observations of the subject coded to an emotional model. In an example, the emotional model can include a Facial Action Coding System (FACS) model. In an example, the emotional model can include a derivative of FACS, such as a degree of emoting at a given event or time period. In an example, the derivative model can include an appeal (e.g., valence) or engagement model. In an example, the observations of the subject can include physiological measurements, such as electroencephalography, galvanic skin response, body posture, thermal imaging, functional magnetic resonance imaging (fMRI), among others.

In an example, the receipt module 105 can be arranged to collect emotional data of the subject for a simulation, such as those described above. In this manner, the receipt module 105 can be arranged to both collect performance data and emotional data for scenarios that have not yet been measured for the subject. Further, the control that a simulation can provide to the system 100 can allow for greater granularity of the particular subject of an emotion. For example, a subject may demonstrate anger during a given play. It may be determined that the subject's anger is directed to a particular position on the opposing team. This observation may allow the correlation between the subject and a previous encounter where the subject was hurt by an opposing player in the position.

The plan module 110 can be arranged to determine a plan to achieve a performance goal for the subject. The plan module 110 can be arranged to base the plan on both the performance data and the emotional data. For example, if a hockey player takes a shot and demonstrates frustration as the puck leaves the stick, the plan can include measures to address the frustration, such as trying a different stick, or increased training at shooting. Moreover, the plan can pertain to the subject's contribution to a team, for example. Thus, the plan may include such subject matter as to refrain from signing the subject, or determining when and how to use the subject.

In an example, the plan can include a compatibility analysis of the subject and a teammate. For example, the subject may be performing more poorly than expected from prior performances. At a practice (specific event) the emotional data and performance data can indicate that the subject performs more poorly with a particular teammate but emotes like for the teammate. It can be determined that playing these two players in their current positions is detrimental to the team's effectiveness, but that separating them may lead to other problems. Thus, the plan can indicate that the subject can try an alternative position in which the subject's feelings do not interfere with the subject performance. In other examples, the plan can indicate that two players do not like each other and thus play poorly together.

In this example, the plan may indicate that they should not, for example, play on the same line but rather on different lines.

In an example, the plan can include a predictive assessment of the subject in the sport. For example, a collegiate player with good performance statistics can be observed during an interview discussing professional team options.

The emotional data for the subject may indicate, when the subject is asked about this team, extreme anxiety, shame, anger, or other emotional components that are incongruous with the event. The plan can include a determination that the subject does not want to join this team that, or is having difficulty handling the pressure of moving to professional sports. Thus, the plan can indicate that the player should not be signed by this team.

The presentation module 115 can be arranged to present the plan to the user 120. In an example, the presentation module 115 can be arranged to present the plan as a static report (e.g., printed or in an electronic print format). In an example, the presentation module can be arranged to present the plan via an interactive interface on the terminal 125. In an example, the presentation module 115 can be arranged to present a summary of the emotional data to the user 120. For example, a coach can have a tablet with a list of players, including the subject, during a game. The summary of the emotional data can be distilled to indicate that a player is hurt, frustrated, angry, or otherwise impaired. The sometimes complex underlying emotional data of the subject, such as a social smile when asked how she is doing, can be too much for the coach to process in the heat of the game. Thus, a customizable summary of the emotional data can be an effective management tool for the coach. In an example, the presentation module 115 can be arranged to present a representation of the specific performance event. This can be useful, for example, for a coach reviewing the subject after a game. For example, the representation can include a recording of a play in which the subject participated. The representation can be modified to include the summary of the emotional data. Thus, the coach can quickly ascertain both the context and the emotional conclusion of the subject that, for example, led to a mistake that cost the team a game.

In an example, the plan can include a situational analysis of the subject during the specific performance event. The situational analysis can include event statistics (e.g., where or when the event occurred, what position the subject was playing, teammates at the time, opposing players, etc.), representations of the event (e.g., a recording, positional representation, etc.), evaluation of the subject's performance, etc. The plan can include a correspondence of the emotional data to the subject's actions during the specific performance event. In this example, the subject can be the user 120. Thus, the subject can perceive their own emotional response to a given situation that they can review. Such a feedback loop can allow the subject to identify weaknesses and improve them in the future. Moreover, the emotional data can help the subject to identify future situations in which the subject may experience the same performance failure even if some of the specifics are different. For example, the subject may have some subconscious animosity towards a particular opponent. The animosity may cause the subject to act recklessly and ineffectively. The emotional feedback can permit the subject to identify this animosity, perceive the effect of the animosity in a future competition, and adjust accordingly.

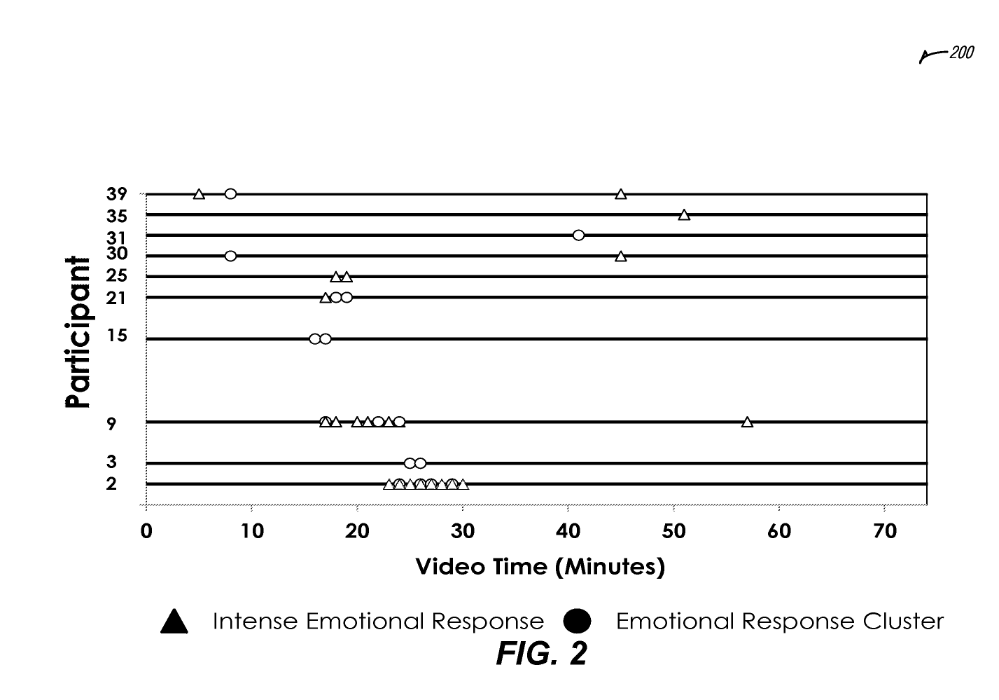

FIG. 2 illustrates an example of a chart 200 of performance feedback element. The chart 200 includes a time based graph indicating periods of different emotional response during a video. The chart 200 is an example of the emotional data that can be, for example, shown to a subject during a video of a botched scoring opportunity. The chart 200 also illustrates an example of the emotional summary described above.

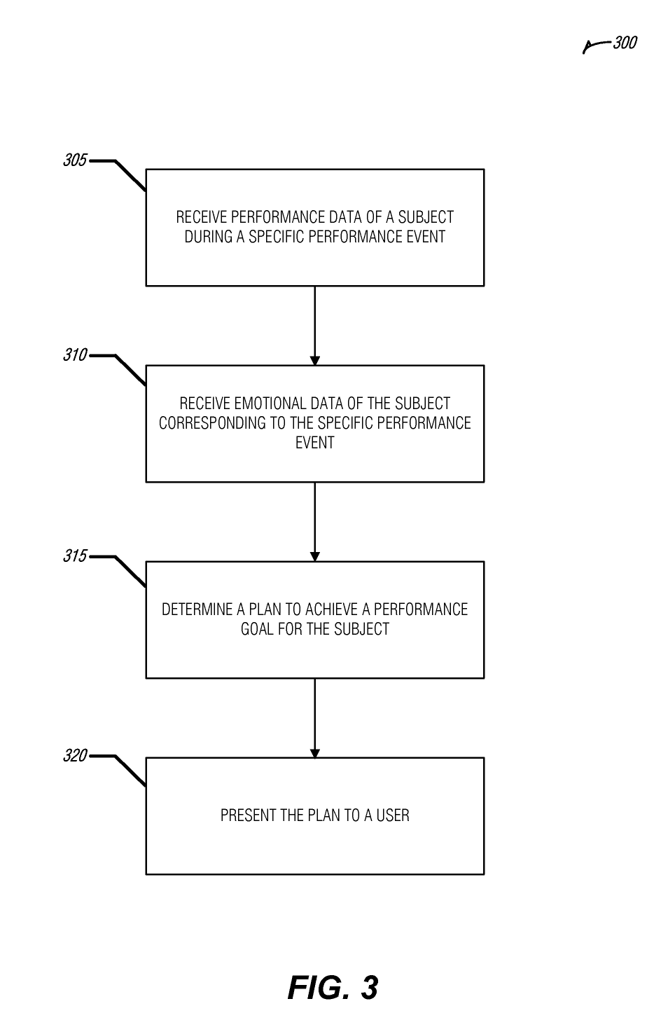

FIG. 3 illustrates an example of a method 300 for emotional analytics for performance improvement. Elements discussed above with respect to FIG. 1 can be used to implement some or all of the operations of the method 300. However, any hardware element configured to perform the below operations can be used.

At operation 305 performance data of a subject can be received. The performance data can include a specific performance event. In an example, the performance data can correspond to a sport. In an example, the performance data can include performance statistics of the subject in the sport. In an example, the performance data can include performance statistics of a person other than the subject in the sport. In an example, the performance statistics are for a portion occupied by the subject.

In an example, the specific performance event can be of a time period during a competitive event of the sport. In an example, the specific performance event can be of a time period during a non-competitive event of the sport. In an example, the specific performance event can be a public interview.

In an example, receiving the performance data can include presenting a simulation of an event of the sport to the subject. In an example, receiving the performance data can include collecting performance data of the subject for the simulation.

At operation 310 emotional data of the subject corresponding to the specific performance event can be received. In an example, receiving the emotional data can include presenting a simulation of an event of the sport to the subject. In an example, receiving the emotional data can include collecting emotional data of the subject for the simulation.

At operation 315 a plan to achieve a performance goal for the subject can be determined based on both the performance data and the emotional data. In an example, the plan can include a compatibility analysis of the subject and a teammate. In an example, the plan can include a predictive assessment of the subject in the sport. In an example, the plan can include a situational analysis of the subject during the specific performance event. The situational analysis can include corresponding (e.g., linking) the emotional data to subject actions

At operation 320 the plan can be presented to a user. In an example, presenting the plan to the user can include presenting a summary of the emotional data to the user. In an example, presenting the plan to the user can include presenting a representation of the specific performance event.

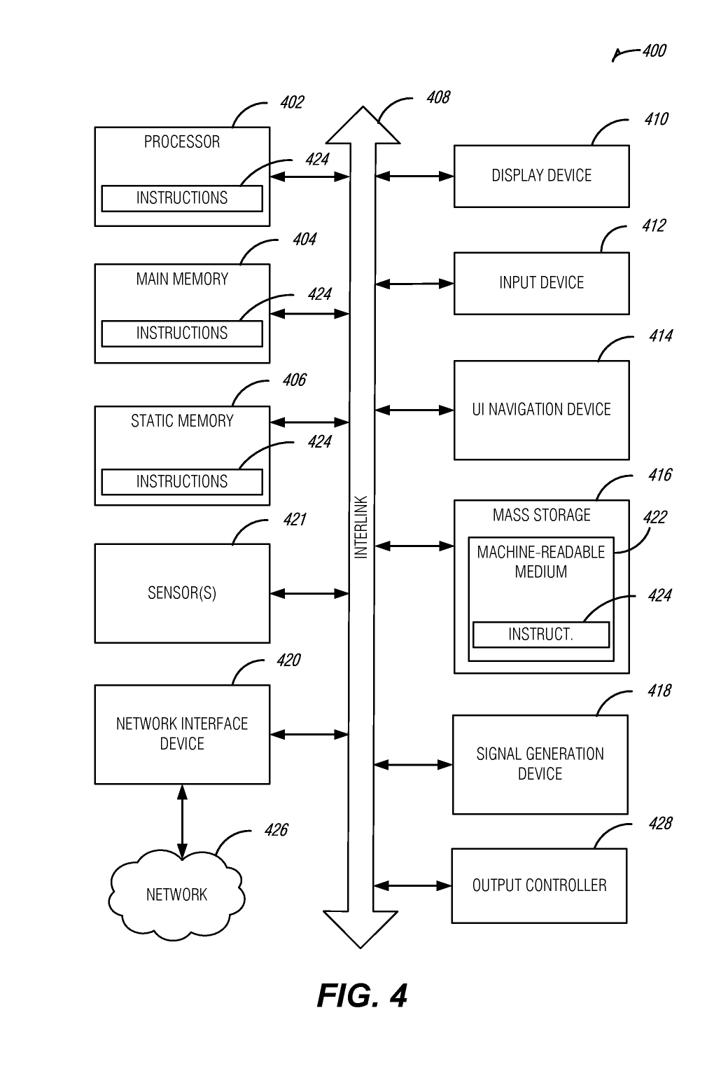

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

### Additional Notes & Examples

Example 1 includes subject matter (such as a device, apparatus, or network interface device for reduced host sleep interruption) comprising a host interface coupled to a machine that is asleep, the host interface configured to communicate data from the network interface device to the machine, the machine configured to wake upon receipt of the data from the host interface. The subject matter may also comprise a buffer and a module. The module may be configured to receive a packet via a receive chain, the receive chain coupling the network interface device to a network. The module may also be configured to determine, using a first analysis operation, a preliminary packet type for the packet. The module may also be configured to place in the buffer, in response to determining that the packet is of a first preliminary type, the packet. The module may also be configured to communicate, in response to determining that the packet is of a second preliminary type, the packet to the machine using the host interface. The module may also be configured to determine, in response to deactivation of the receive chain using a second analysis operation, a secondary packet type for the packet in the buffer. The module may also be configured to process, in response to determining that the packet is of a first secondary type, the packet from the buffer without communicating with the machine. The module may also be configured to communicate, in response to determining that the packet is of a second secondary type, the packet to the machine using the host interface.

Example 1 can include subject matter (such as a method, means for performing acts, or machine readable medium including instructions that, when performed by a machine cause the machine to performs acts) comprising receiving performance data of a subject including a specific performance event, receiving emotional data of the subject corresponding to the specific performance event, determining a plan to achieve a performance goal for the subject based on both the performance data and the emotional data, and presenting, using a hardware processor, the plan to a user.

In example 2, the subject matter of Example 1 can optionally include, wherein the performance data of the subject corresponds to a sport.

In example 3, the subject matter of Example 2 can optionally include, wherein the performance data includes performance statistics of the subject in the sport.

In example 4, the subject matter of any of examples 2-3 can optionally include, wherein the performance data includes performance statistics of a person other than the subject in the sport.

In example 5, the subject matter of Example 4 can optionally include, wherein the performance statistics are for a position occupied by the subject.

In example 6, the subject matter of any of Examples 2-5 can optionally include, wherein the specific performance event is of a time period during a competitive event of the sport.

In example 7, the subject matter of any of Examples 2-6 can optionally include, wherein the specific performance event is of a time period during a non-competitive event of the sport.

In example 8, the subject matter of Example 7 can optionally include, wherein the specific performance event is a public interview.

In example 9, the subject matter of any of Examples 2-8 can optionally include, wherein receiving the performance data includes presenting a simulation of an event of the sport, and collecting performance data of the subject for the simulation.

In example 10, the subject matter of any of Examples 2-9 can optionally include, wherein receiving the emotional data includes presenting a simulation of an event of the sport, and collecting emotional data of the subject for the simulation.

In example 11, the subject matter of any of Examples 2-10 can optionally include, wherein the plan includes a compatibility analysis of the subject and a teammate.

In example 12, the subject matter of any of Examples 2-11 can optionally include, wherein the plan includes a predictive assessment of the subject in the sport.

In example 13, the subject matter of any of Examples 2-12 can optionally include, wherein the plan includes a situational analysis of the subject during the specific performance event—the situational analysis including corresponding the emotional data to subject actions during the specific performance event'and wherein the user is the subject.

In example 14, the subject matter of any of Examples 1-13 can optionally include, wherein presenting the plan includes presenting a summary of the emotional data to the user.

In example 15, the subject matter of Example 14 can optionally include, wherein presenting the plan includes presenting a representation of the specific performance event.

Example 16 can include, or can optionally be combined with the subject matter of any of Examples 1-16 to include, subject matter (such as a device, apparatus, or network interface device for emotional analytics for performance improvement) comprising a receipt module arranged to receive performance data of a subject including a specific performance event, and receive emotional data of the subject corresponding to the specific performance event. The subject matter of Example 16 can also include a plan module arranged to determine a plan to achieve a performance goal for the subject based on both the performance data and the emotional data, and a presentation module arranged to present the plan to a user.

In example 17, the subject matter of Example 16 can optionally include, wherein the performance data of the subject corresponds to a sport.

In example 18, the subject matter of Example 17 can optionally include, wherein the performance data includes performance statistics of the subject in the sport.

In example 19, the subject matter of any of Examples 17-18 can optionally include, wherein the performance data includes performance statistics of a person other than the subject in the sport.

In example 20, the subject matter of Example 19 can optionally include, wherein the performance statistics are for a position occupied by the subject.

In example 21, the subject matter of any of Examples 17-20 can optionally include, wherein the specific performance event is of a time period during a competitive event of the sport.

In example 22, the subject matter of any of Examples 17-21 can optionally include, wherein the specific performance event is of a time period during a non-competitive event of the sport.

In example 23, the subject matter of Example 22 can optionally include, wherein the specific performance event is a public interview.

In example 24, the subject matter of any of Examples 17-23 can optionally include, wherein to receive the performance data includes the receipt module arranged to present a simulation of an event of the sport, and collect performance data of the subject for the simulation.

In example 25, the subject matter of any of Examples 17_{—}24 can optionally include, wherein to receive the emotional data includes the receipt module arranged to present a simulation of an event of the sport, and collect emotional data of the subject for the simulation.

In example 26, the subject matter of any of Examples 17-25 can optionally include, wherein the plan includes a compatibility analysis of the subject and a teammate.

In example 27, the subject matter of any of Examples 17-26 can optionally include, wherein the plan includes a predictive assessment of the subject in the sport.

In example 28, the subject matter of any of Examples 17-27 can optionally include, wherein the plan includes a situational analysis of the subject during the specific performance event—the situational analysis including a correspondence of the emotional data to subject actions during the specific performance event—and wherein the user is the subject.

In example 29, the subject matter of any of Examples 16-28 can optionally include, wherein to present the plan includes the presentation module arranged to present a summary of the emotional data to the user.

In example 30, the subject matter of Example 29 can optionally include, wherein to present the plan includes the presentation module arranged to present a representation of the specific performance event.

The above detailed description includes references to the accompanying drawings, which form a part of the detailed description. The drawings show, by way of illustration, specific embodiments that may be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A machine-readable medium including instructions that, when executed by a machine, cause the machine to perform operations comprising:
receiving performance data of a subject including a specific performance event;
receiving emotional data of the subject corresponding to the specific performance event;
determining a plan to achieve a performance goal for the subject based on both the performance data and the emotional data; and
presenting, using a hardware processor, the plan to a user.

2. The machine-readable medium of claim 1, wherein the performance data of the subject corresponds to a sport.

3. The machine-readable medium of claim 2, wherein the performance data includes performance statistics of the subject in the sport.

4. The machine-readable medium of claim 2, wherein the specific performance event is of a time period during a competitive event of the sport.

5. The machine-readable medium of claim 2, wherein receiving the emotional data includes:
presenting a simulation of an event of the sport; and
collecting emotional data of the subject for the simulation.

6. The machine-readable medium of claim 2, wherein the plan includes a compatibility analysis of the subject and a teammate.

7. The machine-readable medium of claim 2, wherein the plan includes a predictive assessment of the subject in the sport.

8. The machine-readable medium of claim 2, wherein the plan includes a situational analysis of the subject during the specific performance event, the situational analysis including corresponding the emotional data to subject actions during the specific performance event, wherein the user is the subject.

9. A system comprising:
a receipt module arranged to:
receive performance data of a subject including a specific performance event; and
receive emotional data of the subject corresponding to the specific performance event;
a plan module arranged to determine a plan to achieve a performance goal for the subject based on both the performance data and the emotional data; and
a presentation module arranged to present the plan to a user.

10. The system of claim 9, wherein the performance data of the subject corresponds to a sport.

11. The system of claim 10, wherein the performance data includes performance statistics of the subject in the sport.

12. The system of claim 10, wherein the specific performance event is of a time period during a competitive event of the sport.

13. The system of claim 10, wherein to receive the emotional data includes the receipt module arranged to:
present a simulation of an event of the sport; and
collect emotional data of the subject for the simulation.

14. The system of claim 10, wherein the plan includes a compatibility analysis of the subject and a teammate.

15. The system of claim 10, wherein the plan includes a predictive assessment of the subject in the sport.

16. The system of claim 10, wherein the plan includes a situational analysis of the subject during the specific performance event, the situational analysis including a correspondence of the emotional data to subject actions during the specific performance event, wherein the user is the subject.

17. A method comprising:
receiving performance data of a subject including a specific performance event;
receiving emotional data of the subject corresponding to the specific performance event;
determining a plan to achieve a performance goal for the subject based on both the performance data and the emotional data; and
presenting, using a hardware processor, the plan to a user.

18. The method of claim 17, wherein the performance data of the subject corresponds to a sport.

19. The method of claim 18, wherein the performance data includes performance statistics of the subject in the sport.

20. The method of claim 18, wherein the specific performance event is of a time period during a competitive event of the sport.

21. The method of claim 18, wherein receiving the emotional data includes:
presenting a simulation of an event of the sport; and
collecting emotional data of the subject for the simulation.

22. The method of claim 18, wherein the plan includes a compatibility analysis of the subject and a teammate.

23. The method of claim 18, wherein the plan includes a predictive assessment of the subject in the sport.

24. The method of claim 18, wherein the plan includes a situational analysis of the subject during the specific performance event, the situational analysis including corresponding the emotional data to subject actions during the specific performance event, wherein the user is the subject.
